(19) United States
(12) Patent Application Publication
(10) Pub. No.: US 2011/0064035 A1
(43) Pub. Date: Mar. 17, 2011

(54) Method and Apparatus for Reducing Multi-User-Interference in a Wireless Communication System

(76) Inventors: Igor Moáco Guerreiro, Fortaleza - CE (BR); Charles Casimiro Cavalcante, Fortaleza - CE (BR); Darlan Cavalcante Moreira, Fortaleza - CE (BR); Dennis Hui, Cary, NC (US); Icaro L. Silva, Fortaleza - CE (BR)

(21) Appl. No.: 12/634,250

(22) Filed: Dec. 9, 2009

Related U.S. Application Data
(60) Provisional application No. 61/241,819, filed on Sep. 11, 2009.

(51) Int. Cl. H04B 15/00; H04W 72/00

(52) U.S. Cl. 370/329; 455/501

(57) ABSTRACT

According to the teachings presented herein, each base station in a group of base stations is linked to an associated terminal as a receiver-transmitter pair. These receiver-transmitter pairs reuse channelization resources, such that each terminal represents a source of other-cell interference (also referred to as multi-user interference or MUI) for other terminals in neighboring cells that are reusing all or some of the same channelization resources. Accordingly, the base stations implement a gaming-based algorithm to mitigate MUI for the multiple-input-multiple-output (MIMO) uplink signals received from their associated terminals. More particularly, each base station functions as a player in a game, in which the allowed gaming action is the selection of the precoding matrix to be used for MIMO uplink transmissions to the base station from an associated terminal.

### RELATED APPLICATIONS

This application claims priority from the U.S. provisional patent application filed on 11 Sep. 2009 and assigned Application No. 61/241,819, and that application is incorporated herein in its entirety.

### FIELD OF THE INVENTION

The present invention generally relates to wireless communication networks, and particularly relates to reducing multi-user interference (MUI) in wireless communication networks that employ Multiple-Input-Multiple-Output (MIMO) transmission.

### BACKGROUND

Multiple transmit and receive antennas (for MIMO transmit/receive processing) can be used to mitigate multi-user interference (MUI) if they are used according to some intelligent transmission technique. For instance, the use of directional antennas and antenna arrays has long been recognized as an effective technique to reduce MUI [1]. If multiple antennas are also employed to perform spatial multiplexing (SM), where data are transmitted over multiple transmit antennas [2], the spectral efficiency can be further increased.

By using only a subset of the available transmit antennas, it is possible to mitigate the MUI by using the excess antennas to obtain a diversity gain. With a simple linear precoding process, the antenna subset which yields the least MUI for each user is selected. After that, SM is performed in the selected antennas.

Different criteria have been used for the subset selection such as maximizing the channel capacity [3], maximizing the post-processing signal-to-noise ratio (SNR) [4] and maximizing the minimum singular value (MMSV) of the channel matrix [4]. Those criteria can be employed straightforwardly in scenarios with MUI. For instance, the post-processing SNR maximization criterion becomes post-processing signal-to-interference-plus-noise ratio (SINR) maximization. Also, it is possible to perform the subset selection through centralized optimization by exhaustive searching over all possible antenna combinations.

Nowadays, the information feedback channel is considered limited in terms of bit rate. Thus, the exhaustive searching approach might be not feasible in practical systems due to the high computational complexity and excessive signaling load requirements to obtain the optimal solution. Moreover, linear receivers are widely used to separate the incoming data streams. But, the capacity maximization criterion is not specialized to this kind of receivers and it might result in a probable suboptimal solution. The MMSV criterion does not take into account the influence of MUI. That is, it does not work well in regime of low signal-to-interference ratio (SIR).

Game theory has also been adopted to solve many problems in communication systems by modeling such systems in a distributed way [5-7]. In particular, game theory has been employed to determine optimal precoding/multiplexing matrixes for multipoint-to-multipoint communication systems [8]. However, it does not appear that any existing technology applies game theory to the problem of antenna subset selection in uplink multi-user communications, via a linear precoding process.

### SUMMARY

According to the teachings presented herein, each base station in a group of base stations is linked to an associated terminal as a receiver-transmitter pair. These receiver-transmitter pairs reuse channelization resources, such that each terminal represents a source of other-cell interference (MUI) for other terminals in neighboring cells that are reusing all or some of the same channelization resources. Accordingly, the base stations implement a gaming-based algorithm to mitigate MUI for the MIMO uplink signals received from their associated terminals. More particularly, each base station functions as a player in a game, in which the allowed gaming action is the selection of the precoding matrix to be used for MIMO uplink transmissions to the base station from an associated terminal.

To make that selection competitive among the base stations “playing the game,” each round of game play involves each base station making its own precoding matrix selection while assuming that the other base stations hold their selections fixed. For example, each base station determines a covariance estimate for MUI that depends on the precoding matrixes in use at the other terminals, and it evaluates a utility function over the range of available precoding matrix selections. That utility function depends for its value on the covariance estimate and on the particular selection of precoding matrix for the associated terminal. As an example, the utility function maximizes the minimum SINR determined for the MIMO uplink signals from the associated terminal, over all k MIMO streams. Once the quality-maximizing precoding matrix is found and selected, it can be sent to the associated terminal (e.g., by identifying its index within a predefined set of precoding matrixes).

As such, in each round of game play, each base station picks the precoding matrix that maximizes received uplink signal quality at the base station, for the base station's associated terminal, while assuming that the other base stations are holding the precoding matrixes of their associated terminals fixed. However, after each round of game play, the updated precoding matrix selections can be exchanged among all base stations, or estimated/inferred by each base station and a new round of game play is commenced according to the new precoding matrix selections.

Game play can be iterated in this fashion until an equilibrium point is reached by the base stations as regards precoding matrix selections, or until an allowed iteration limit is reached—to guard against non-convergence problems. If the iteration limit bound is reached, each given base station uses another algorithm—e.g., a non-iterative algorithm—to select the precoding matrix to be used by its associated terminal. For example, the base station may use a MMSV algorithm for precoding matrix selection.

With the above understanding in mind, in one or more embodiments, the present invention proposes an antenna subset selection game for a competitive MIMO system in an uplink multi-user scenario. The game structure aims at maximizing the minimum SINR per stream of each user.

### BRIEF DESCRIPTION OF THE DRAWINGS

FIG. 1 is a block diagram of one embodiment of a wireless communication network that includes two (neighboring) base stations (BSs), each serving a respective item of user equipment (UE).

FIG. 2 is a block diagram of one embodiment of a UE, such as a wireless communication terminal.

FIG. 3 is a logic flow diagram of one embodiment of a method of playing an interference-reducing game at a given BS.

FIG. 4 is a diagram of one embodiment of iterative game play involving two neighboring BSs, wherein needed game information is exchanged through a base station controller (BSC).

FIG. 5 is a diagram of one embodiment of iterative game play involving two neighboring BSs, wherein each BS estimates needed game information.

FIG. 6 is a plot of example bits exchanged per game iteration.

FIGS. 7-18 are plots of various example bit error rates for different communication scenarios, for one or more embodiments of interference-reduction game play, as taught herein for neighboring base stations.

FIG. 19 is a plot of an example Nash equilibrium probability.

FIG. 20 is a plot of average numbers of game iterations, for different communication scenarios.

FIG. 21 is a block diagram of example embodiments of a BS and a BSC configured for interference-reduction game play, shown in conjunction with an example UE (e.g., a terminal).

FIG. 22 illustrates Table 1, illustrating example signal-to-interference (SIR) ratios for different communication scenarios.

### DETAILED DESCRIPTION

The following notation is used throughout this document. Uppercase and lowercase boldface denote matrixes and vectors, respectively. The operators E{•},∥•∥,D[•],|•|,┌•┐,(•)^{H} and tr(•) stand for expectation, norm operator, decision operator, modulus, ceil, hermitian and trace operator, respectively.

Consider a multi-user scenario with K users spread over Q cells. The reuse factor is equal to the unit and there is no intracell interference. On the other hand, there are co-channel receiver-transmitter pairs (links) in uplink communication that share time and bandwidth resources causing intercell interference. To achieve this scenario described above, a multiple access technique can be adopted in each cell, such as single-carrier frequency-division multiple access (SC-FDMA) [9]. Therefore, for a given set of resources, there are at most Q neighboring links, which yields Q−1 interfering links for each user equipment (UE) in a cell, that interfere with each other. Thus, considering the worst case, the set of neighboring links is defined as follows:

Γ={1, . . . ,Q}. (Eq. 1)

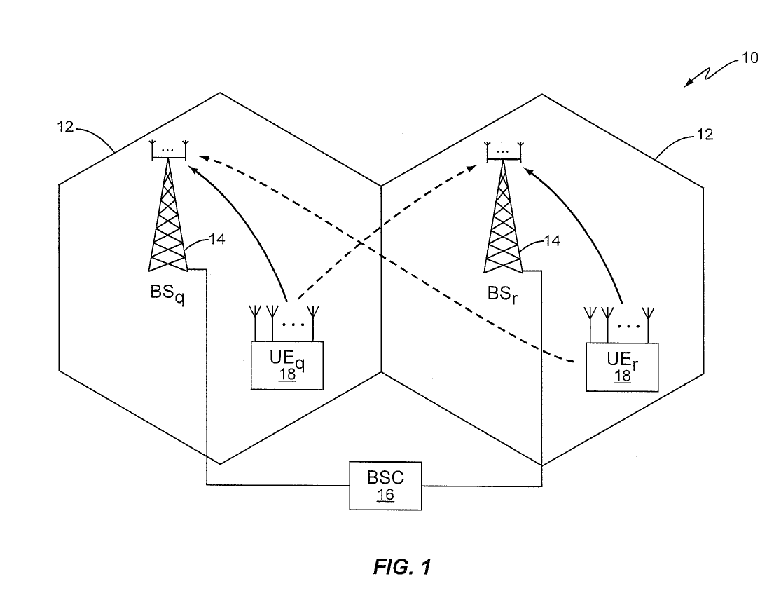

In addition, each base station (BS) is connected to a base station controller (BSC) through, for example, a high-speed wired link in order to exchange information, if this feature is needed. The link from a BS to the BSC is called direct wired link and the opposite is called reverse wired link. Further, the downlink (link from each BS to a UE) is limited in terms of bit rate and it is called a limited-feedback link. FIG. 1 illustrates a 2-user scenario where two items of UE share resources (the remaining K−2 users are omitted). For convenience, each item of UE is simply referred to as a UE.

More particularly, FIG. 1 depicts an example wireless communication network 10, including a number of cells 12, each including a corresponding base station (BS) 14. The BSs 14 are communicatively coupled to a (centralized) base station controller (BSC) 16. The arrangement provides cell-based wireless communication service to a number of UEs 18. Of interest herein is the case where one BS 14 (e.g., BS_{q}) supports a given UE 18 (e.g., UE_{q}) in a first cell 12, and another neighboring BS (e.g. BSᵣ) supports another UE 18 (e.g., UEᵣ) on some or all of the same channel resources.

In this scenario, UE_{q} acts as a source of interference bearing on reception of uplink transmissions between UEᵣ and BSᵣ. Likewise, UEᵣ acts as a source of interference bearing on reception of uplink transmissions between UE_{q} and BS_{q} (multi-user interference or MUI). If the two BSs 14 (BS_{q} and BSᵣ) “play” an interference reduction game between them, iterative game play can drive each BS 14 to identify the MIMO precoding matrix to be used by its respective UE 18, for reducing the MUI.

In more detail, the UE_{q} is the q-th source that transmits precoded and spatially multiplexed symbol vectors x_{q} to the q-th BS (BS_{q}). The symbol vectors x_{q} are defined as

$${x}_{q} = \sqrt{\frac{1}{N}} {F}_{q} {s}_{q} , \qquad ( Eq . 2 )$$

where F_{q} is the M_{T}×N precoding matrix and s_{q} is the N×1 vector of SM symbols sₖ defined as

$${s}_{q} = {[ {s}_{k} ]}_{k ∈ η {=}^{Δ} \{ 1 , … , N \}} .$$

The q-th base station, BS_{q}, as the q-th destination also receives interfering signals from the other Q−1 links. Further, η denotes the index set of the un-coded symbol streams. Also, one may assume M_{T}, N and M_{R} as being the number of available transmit antennas, the number of radio frequency (RF) chains and the number of receive antennas, respectively.

The sampled symbol vector received by the q-th BS is

$${y}_{q} = {H}_{qq} {x}_{q} + {\sum }_{r = 1 , r \neq q}^{Q} \sqrt{{g}_{rq}} {H}_{rq} {x}_{r} + {n}_{q} , \qquad ( Eq . 3 )$$

where H_{qq} is the channel matrix between source q and destination q and n_{q} is the zero-mean circularly symmetric complex Gaussian (ZMCSCG) noise vector with covariance matrix NₒI. On the right-hand side of (Eq. 3), the second term refers to the MUI caused by the other links and received by the q-th BS. The fading between each transmit and receive antenna is assumed to be independent, modeled by ZMCSCG random variables and quasi-static over a data block of L symbols.

Also, it is assumed that each BS knows the channel state information (CSI) for its associated UE perfectly. Further, in one or more embodiments, each BS knows the CSI for the other, interfering UEs. The constant g_{rq} is a gain that depends on the path loss of each interfering signal, here modeled in a simplified way, as follows:

$${g}_{rq} = {( \frac{{d}_{qq}}{{d}_{rq}} )}^{α} .$$

The constant α is the path loss exponent and its value depends on the propagation media. Finally, d_{qq} and d_{rq} are the distance, both in units of length, from UE_{q} to BS_{q} and from UEᵣ to BS_{q}, respectively.

As for estimations carried out in support of the method proposed herein, the system model uses an initial estimation step in order to obtain H_{qq} (and optionally H_{rq}) at the q-th BS. It is considered perfect estimation of those matrixes and the signaling load is not concerned. That is, it is expected that a previous step is performed so that all this information is obtained perfectly.

For each UE, the average transmit power is constant and given by

$$E \{ {‖ {x}_{q} ‖}^{2} \} = \frac{1}{N} tr ( {F}_{q} {F}_{q}^{H} ) = {P}_{q} , ∀ q ∈ Γ , \qquad ( Eq . 4 )$$

where “E” denotes the expected value, P_{q} is the average transmitted power in units of energy per signaling period. Also, the symbols are assumed to be uncorrelated and E{s_{q}s_{q}^{H}}=I.

At each receiver (e.g., at the receiver of each UE 18), the MUI is treated as additive noise. This assumption is due to the fact that interference cancellation algorithms need some information (e.g., CSI) from interfering users [10], thereby increasing the system signaling load. Hence, the estimated symbol vector at the q-th BS is defined as

ŝ_{q}=D[G_{q}^{H}y_{q}], (Eq. 5)

where G_{q} represents the minimum mean-square error (MMSE) stage [8, 11] and it is defined as

G_{q}=R_{-q}⁻¹H_{qq}R_{q}(I+F_{q}^{H}H_{qq}^{H}R_{-q}⁻¹H_{qq}F_{q})⁻¹, (Eq. 6)

where R_{-q} [symbol] NₒI+Σ_{r≠q}|g_{rg}|H_{rg}FᵣFᵣ^{H}H_{rq}^{H} corresponds to the interference-plus-noise covariance matrix estimated by the q-th BS.

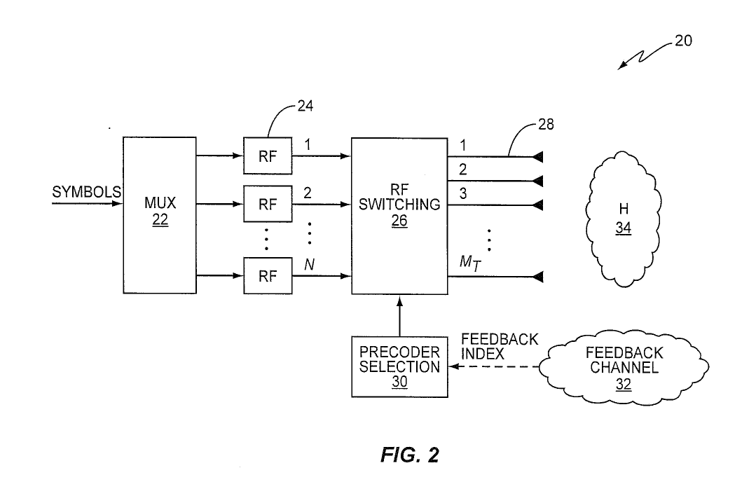

Before transmitting, each UE selects a precoding matrix F, which is related to an antenna subset. Generally, for a given UE, the selection of F is based on some information fed back by the BS with which the UE is associated, as illustrated in FIG. 2.

In particular, FIG. 2 illustrates example transmitter circuits 20 that may be included in any one or more of the UEs 18, introduced in FIG. 1. The circuitry includes a multiplexer 22, RF modulators 24, RF switching circuits 26, a number of (MIMO) transmit antennas 28, and a precoding matrix selection circuit 30. In operation, symbols are multiplexed into a number of streams, each of which is modulated by one of the RF modulators 24. The modulated stream(s) are input into the RF switching circuit 26, where they are applied with particular weights to particular ones of the transmit antennas 28, according to a precoding matrix selection, as made by the precoding matrix selection circuit 30. The resultant uplink MIMO stream(s) are transmitted through an uplink propagation channel H 34, and precoding matrix selection feedback is received through a downlink feedback propagation channel 32.

Consider a codebook W as being the set of all precoding matrixes available for every entity in the system (e.g., for all UEs 18). For purposes of antenna subset selection, one may define each element of W as a M_{T}×N submatrix of an identity matrix I. That is, the unique non-null entry of each column of this submatrix selects a transmit antenna. In order to index the elements of W, assume an index set

$$I {=}^{Δ} \{ 1 , 2 , … , ( \begin{matrix}{M}_{T} \\ N\end{matrix} ) \} .$$

Thus, a bijective function ƒ:I [symbol] W maps the elements of I onto the elements of W properly. For example, for M_{T}=3 and N=2:

$$W = \{ [ \begin{matrix}1 & 0 \\ 0 & 1 \\ 0 & 0\end{matrix} ] , [ \begin{matrix}1 & 0 \\ 0 & 0 \\ 0 & 1\end{matrix} ] , [ \begin{matrix}0 & 0 \\ 1 & 0 \\ 0 & 1\end{matrix} ] \} I = \{ 1 , 2 , 3 \}$$

$$f ( 1 ) = [ \begin{matrix}1 & 0 \\ 0 & 1 \\ 0 & 0\end{matrix} ] f ( 2 ) = [ \begin{matrix}1 & 0 \\ 0 & 0 \\ 0 & 1\end{matrix} ] f ( 3 ) = [ \begin{matrix}0 & 0 \\ 1 & 0 \\ 0 & 1\end{matrix} ]$$

For the sake of simplicity, it may be assumed that every receiver-transmitter pair has the same configuration, i.e., the same number of RF chains, and transmit and receive antennas. Therefore, each receiver-transmitter pair works with the same codebook W.

As proposed herein, precoder matrix selection game employs a game theory tool to solve the precoding selection problem, based on exploiting its interesting feature of solving optimization problems in a non-centralized way. For example, in one embodiment, there is a defined set of precoder matrixes available for use, wherein a matrix element value of “1” selects a corresponding antenna at the UE, for use in MIMO uplink transmission by the UE. Conversely, a matrix element value of “0” deselects a corresponding such antenna. Thus, the particular precoding matrix selected for a given UE defines the particular subset of antennas used by that UE for MIMO transmission on the uplink.

Based on this approach, each base station in a set of base stations supporting a corresponding set of UEs that are co-channel interferers may be configured to play a game. According to the game, each BS uses the known (or indirectly estimated) precoder matrix selections made by the other BSs for their respective UEs, to estimate the covariance of interference and noise at the BS for its UE's uplink signal. Each BS then uses that covariance estimate to determine the precoder matrix selection that optimizes in some sense the reception of its UE's uplink signal.

For example, in a given round of game play, a given one of the base stations estimates the SINR for each (MIMO) stream received on the uplink from its associated UE, and determines the precoder matrix selection that maximizes the minimum one of the (per-stream) SINRs. Each BS in the overall set of BSs carries out the same selection processing for its associated UE, in the given round of game play. Game play thus advances to the next iteration with each BS updating its covariance estimate in view of the new precoder matrix selections. In one embodiment, such information is shared among the game-playing BSs, such as through a BSC, while in another embodiment, each BS measures pilot or other reference signals, as transmitted by the interfering UEs using their newly selected precoder matrixes.

More broadly, the contemplated game uses the fundamental model of game theory. The three key components of the game model include: (1) the set of players; (2) the set of actions; and (3) the set of objective functions. As for the set of players, in general, the players are the systemic entities that are able to act as rational decision-makers. They belong to the set of players which, in the “game” described herein, is the same set F defined in (Eq. 1). That is, the players are the same receiver-transmitter pairs (UE, BS) previously referred to as “neighboring links.”

As for the set of actions, for the q-th player, an action, drawn from the set of available actions A_{q}, stands for the choice of some precoding matrix in W, which means that

A_{q}=W, ∀qεΓ, (Eq. 7)

and the joint set of the action space of all players is the Cartesian product A=A₁×A₂× . . . A_{Q}. In fact, this decision rule behind an action is called strategy. But which action a player will make depends on information available to that player. One may specify this information as being the interfering term inherent in the SINR expression, which will be described later. Once a player determines or otherwise obtains this information, that player will be able to make a decision following the player's strategy.

As for the set of objective functions, the outcomes of the game are represented by the output values of the objective (or utility) functions. Moreover, these functions must be chosen so that an action of a player somehow impacts the other players. For the nonzero-sum game contemplated in one or more embodiments herein, the q-th player observes a particular outcome (payoff) through its own utility function u_{q} after an action tuple made by all the players in a game iteration, such that

u_{q}:A→ [symbol] ,∀qεΓ. (Eq. 8)

It is worth noting that a given player need not be aware of the other players' utility functions, which turns the game with incomplete information.

From the system model in (Eq. 3), the SINR in the k-th data stream after the MMSE stage at the q-th BS is given by [8] as

$${SINR}_{k , q} = \frac{1}{{[ {( I + {F}_{q}^{H} {H}_{qq}^{H} {R}_{- q}^{- 1} {H}_{qq} {F}_{q} )}^{- 1} ]}_{k , k}} - 1 , \qquad ( Eq . 9 )$$

with F_{-q} [symbol] (Fᵣ)_{r≠q}. The subscript −q denotes all the players belonging to Γ except the q-th player. From (Eq. 9), one sees that there exist a conflict of interests among the players, since R_{-q} is a function of the precoding matrices chosen by the interfering users. Thus, R_{-q} is the information that the q-th player has to realize at each game iteration. Thus, one may advantageously define the utility function of the q-th player as follows below:

$${u}_{q} ( {F}_{q} , {F}_{- q} ) = {min}_{k} {SINR}_{k , q} , ∀ k ∈ N , ∀ q ∈ Γ . \qquad ( Eq . 10 )$$

The motivation for maximizing the minimum SINR comes from the intuition that the performance of the receiver should improve as the smallest value of the SINR increases [4]. Here, the “smallest” SINR value is the minimum per-stream SINR, for the multi-stream MIMO uplink between a given one of the base station's playing the game, and its associated UE.

As for the game formulation, the neighboring links were identified as being the contenders in the system. Therefore, one may consider each one a rational decision-maker, i.e., a player in the game. From the game standpoint, each player contends for the maximization of its own SINR. In practice, each player's strategy is to select one of the precoding matrixes in W after determining or otherwise obtaining the information R_{-q} in a game iteration.

Let G₁ be the non-cooperative and nonzero-sum game, which is written in normal form:

G₁= [symbol] Γ,A,{u_{qεΓ}} [symbol] ,

where the first argument is the set of players, the second is the action space and the last one represents all individual utility functions. Stated in mathematical terms, G₁ has the following structure:

$$( {G}_{1} ) \text{:} \{ \begin{matrix}{maximize}_{{F}_{q}} & {u}_{q} ( {F}_{q} , {F}_{- q} ) \\ subject to & {F}_{q} ∈ W ,\end{matrix} ∀ q ∈ Γ , \qquad ( Eq . 11 )$$

where W is the codebook known by all the players. The term F_{-q} is drawn from the interfering matrix R_{-q}. The manner in which the interference matrix is obtained depends on the distributive algorithm adopted, which is detailed later herein.

As for the game solution, one may define the solution of the game G₁ as being a Nash equilibrium (NE). This kind of equilibrium is established if each player has chosen an action and no one can benefit by changing its action unilaterally while the other ones keep theirs unmodified [12]. Therefore, an action tuple {F*_{q},F*_{-q}} is a NE if

u_{q}(F*_{q},F*_{-q})≧u_{q}(F_{q},F*_{-q}),∀F_{q}εW,∀qεΓ (Eq. 12)

The superscript * denotes that the underlying precoder leads to a NE. The structure above is a convenient form for representing a NE [12].

In other words, an equilibrium point, a NE in this example, means that each UE will transmit with the antenna subset related to its precoding matrix according to the game result. But a particular NE action tuple does not say anything about how this equilibrium point is reached or about uniqueness. The process of reaching an equilibrium point is an important issue and it is usually described by a distributed algorithm. Thus, the teachings herein define a (distributed) algorithm for antenna subset selection.

Thus far, we have not identified the sufficient conditions for the existence of a NE. From [6, 12], some standard results from fixed-point theory and contraction maps are used to state the conditions. (A map T:X→X is a contraction map if there is a positive constant c<1, called the contraction factor, such that d(T x, T y)≦c d(x, y) for all x in X and y in X.) One requires a nonempty, convex and compact codebook W to guarantee the existence of at least one NE. However, the codebook design adopted in a real-world communication system does not necessarily hold to such requirements. Hence, in at least one embodiment proposed herein, another antenna selection algorithm is made available in cases where equilibrium is not reached (e.g., within an allowed number of game iterations). For example, upon failure to reach equilibrium, a BS may fall back to using a non-iterative algorithm.

In particular, it is proposed in one or more embodiments herein to use the maximum minimum singular value (MMSV) algorithm for precoding matrix selection in case of there is no point of equilibrium. Use of the MMSV algorithm has been proposed in [4]. In applying the MMSV algorithm, the q-th BS, after acquiring the estimation of the channel matrix H_{qq}, obtains the singular values of H_{qq} through a singular value decomposition (SVD). Then, it chooses that antenna subset of H_{qq} which yields the largest minimum singular value.

In one embodiment taught herein, a given player recognizes the lack of a NE through use of a trial and error convergence method. That is, the player makes use of the direct application of (Eq. 12), hopping from one precoding matrix to another in order to find an equilibrium point. If no point of equilibrium is found after the check of all possible action tuples, the game ends unsuccessfully and each player switches to the MMSV algorithm for precoder matrix selection.

In simulations and/or empirical observations, it has been noted that a NE does not occur for some small number of channel realizations (less than 10%). Thus, in one approach taught herein, a codebook W is used that is appropriate for the system at hand, despite the fact that it may not yield a NE for all channel realizations. In such cases, which are expected to be few in number, an alternative precoder matrix selection algorithm is used, such as MMSV. Of course, it is also contemplated that, for at least for some types of systems, the codebook W is designed to eliminate or at least greatly reduce cases where a NE is not obtained.

In a particularly advantageous but non-limiting embodiment taught herein, the proposed distributed gaming algorithm is configured for antenna subset selection, and is referred to as the Game-theoRetic Antenna Subset Selection (GRASS) algorithm. The GRASS algorithm is performed at each BS with no coordination among the UEs.

To better understand the GRASS embodiment, note that the broader MUI reduction game play involves a set of UEs that are operating as interferers with respect to one another, by virtue of reusing some or all of the same channelization resources. Each such UE is supported by a given BS. That is, the game involves a set of neighboring (interfering) communication links, with each link formed as a receiver-transmitter pair between a supporting BS and its associated UE.

Now, for the GRASS context, the game action undertaken by each BS playing the game is an antenna subset selection, to be used by its associated UE. After an initial step of channel estimation, each BS is able to play the game G₁. But each BS needs to determine some information from its set of interfering users in order to make rational decisions. In various proposed embodiments, each BS may be provided with the needed information explicitly. Alternatively, each BS may estimate such information, e.g., derive it from measurements, etc. For example, in one or more embodiments, game play involves an iterative exchanging of information between the involved base stations until reaching a point of equilibrium—such exchange may be conducted through a centralized base station controller (BSC).

For the sake of simplicity, we assume perfect channel estimation and an error-free link among BSs and between each BS and UE. Consequently, if there exists a NE point, the system always converges to it ideally. As long as these assumptions hold, the performance of the algorithm in terms of bit error rate (BER) does not depend on how the information exchanging is performed. Of course, in practice, errors in the exchange of information between game players may degrade performance of the game algorithm.

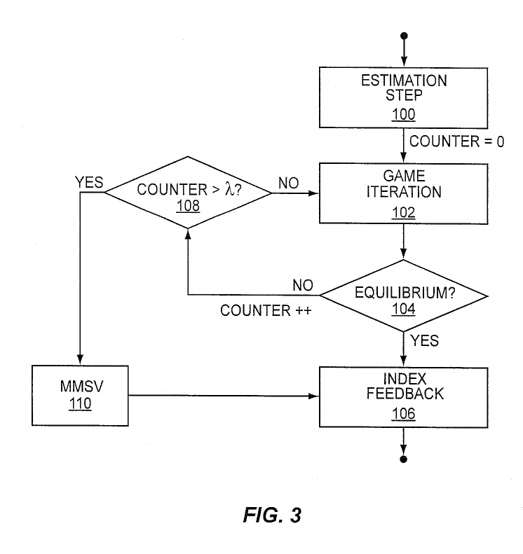

One embodiment of the algorithm as implemented at a game playing base station, for example, is depicted in FIG. 3. The block game iteration is the core of the algorithm and will be discussed in detail later. For now, one sees that a loop counter controls the game iterations and it is upper-bounded by the constant λ, defined as follows below:

$$λ = {[ ( \begin{matrix}{M}_{T} \\ N\end{matrix} ) ]}^{Q} . \qquad ( Eq . 13 )$$

In fact, the value of λ equals the number of all possible action tuples.

Therefore, in this embodiment the block MMSV is triggered if and only if no point of equilibrium is found in λ iterations. Finally, the block index feedback is the last process. Through the limited-feedback link—i.e., the downlink—each BS sends to its UE the index of the precoding matrix related to the NE action. Then, the GRASS algorithm is over and each UE selects an antenna subset based on the index just provided to it by its BS.

The example embodiment of the algorithm may be summarized as: (1) performing an initial step of channel estimation at each base station; and, (2) in each of a bounded number of iterations, the base stations exchange information about the precoder matrix selection made for their respective UEs, with each base station trying to reach the NE point, and with game play continuing until all base stations converge (or until an iteration limit is reached). The finalized precoding matrix selection arrived at by each base station is sent to the UE associated with that base station. Thus, FIG. 3 includes the above-described estimation step 100, a game iteration step 102, an equilibrium check step 104, and precoding matrix index selection feedback step 106, a counter check step 108, and an alternative precoding matrix selection step 110 (e.g., MMSV algorithm).

In one embodiment, a BSC supports game iterations. In this approach, all the BSs playing the game for a given set of intercell-interfering UEs exchange information (through the BSC) in order to reach a NE. First, BSs play G₁ considering an initial index action tuple, for instance (i_{q}[n],i_{-q}[n])|ₙ₌₀=(1,1). Here, the argument n means the stage domain and index action tuple is defined such that

i_{q}=ƒ(F_{q}),i_{q}εI,F_{q}εW,

is the q-th index action which is an output of the bijective function ƒ, and

i_{-q}==[i₁i₂ . . . i_{q-1}i_{q+1} . . . i_{Q}]

is the related index action vector. At the stage n+1, the q-th BS generates an action message m_{q}, which is the string of

$$b = ⌈ {log}_{2} ( \begin{matrix}{M}_{T} \\ N\end{matrix} ) ⌉$$

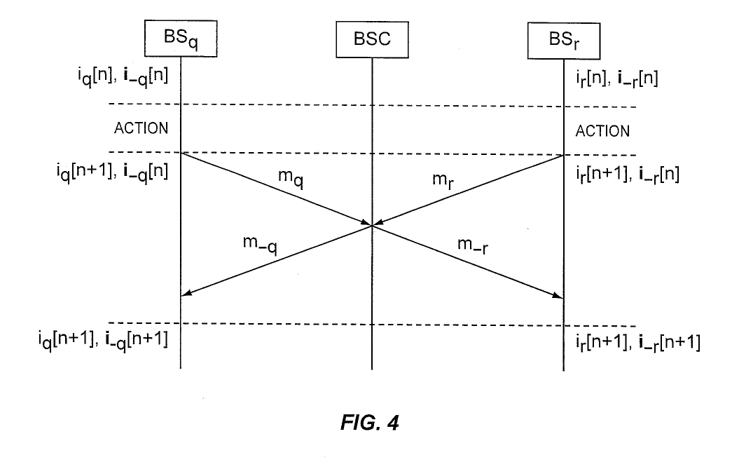

bits representing i_{q}. After that, the BSC receives all the action messages from all the BSs through the direct wired links simultaneously. Then, it assembles a number of Q message vectors such that, for the q-th m_{-q}=[m₁ m₂ . . . m_{q-1} m_{q+1} . . . m_{Q}], and sends them back to each BS through the reverse wired links. FIG. 4 illustrates an example of such processing, for a given iteration.

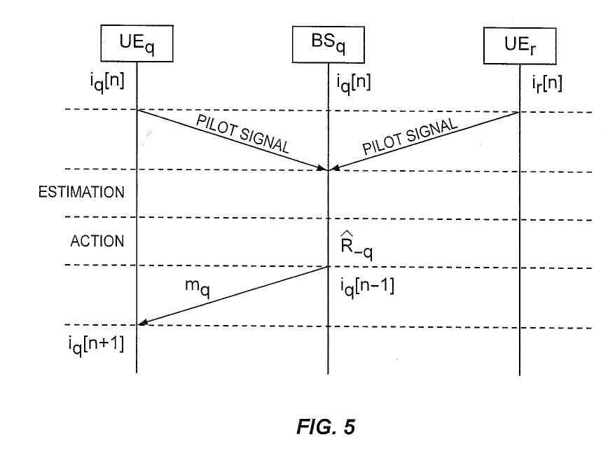

In another approach, each BS exchanges information only with its own UE. That is, the BSC entity is not necessary anymore to enable the game G₁ to be played—i.e., the set of BSs can play the game without need for a centralized entity for exchanging certain game-play information among the BSs. However, such embodiments require an extra estimation step in each iteration of game play. Each such iteration is depicted by way of example in FIG. 5.

First, each of the UE involved in the game transmits a pilot signal considering also an initial index action—i.e., a precoding matrix selection. Then, each BS, by knowing the initial action of its UE, draws the joint action of the others implicitly from an estimation of the matrix R_{-q} denoted by \hat{R}_{-q}. In other words, without benefit of information sharing through a BSC or other entity, each BS playing the game can nonetheless estimate or otherwise infer the precoding matrix selections made by the other BSs for their respective UEs, based on evaluating pilot signals from those other UEs.

Subsequently, each BS plays G₁ and generates the next index action. The stage n+1 is such that each BS sends back the next index action to its associated UE through the limited-feedback link. In other words, the q-th BS generates the message m_{q} and sends it to the q-th UE.

As for scalability, one may assume a constant value for the number of RF chains N. Then, two parameters of the system that are relevant to scalability are Q and M_{T}. Both of them imply the increase in the amount of information exchanged. Also, the way the game iteration is performed determines exactly how many bits are exchanged per iteration. For example, in each game iteration, the number of bits exchanged via the BSC for the direct wired link is b, and (Q−1)b for the reverse wired link. Further, b bits are exchanged for information estimation on the limited-feedback link.

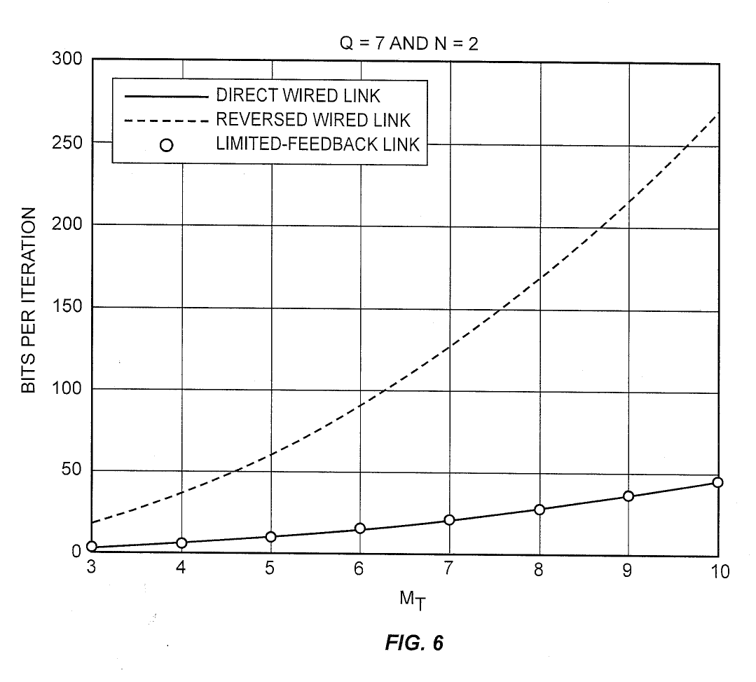

FIG. 6 graphically illustrates that the BSC-based approach demands a larger number of bits than the alternative embodiment that omits the BSC. Another important issue is the number of iterations needed to reach a NE point. That number depends on the channel conditions, and thus varies. However, at least some embodiments put an upper-bound on the game play iterations, such as λ. Further, the configuration of each transceiver can easily be fixed, whereas the number of active mobile terminals has to be flexible. Therefore, the value Q is determinant to evaluate the feasibility of the system in terms of the amount of information exchanged.

Simulation results for game play as contemplated herein for MUI reduction are based on evaluating the BER averaged over at least 10⁶ channel realizations via Monte Carlo simulations. A binary phase shift keying (BPSK) modulation was used, as well as a data block length L=102 symbols in each transmission setup. The number of symbols must be multiple of N due to the fact the symbols are spatially multiplexed through N antennas. For this example discussion, it is assumed that the parameter N ranges from 2 to 3. Therefore, one may choose the value 102 as a multiple of these values. Of course, the length L may be any multiple of N.

Also, channel realizations are independent identically distributed (i.i.d) from block to block. The analysis considers a scenario with only two users (UEs) with varying SIR values observed at each BS. The algorithms used as reference cases are the MMSV proposed in [4], which chooses the antenna subset that yields the equivalent channel with largest minimum singular value, and the exhaustive search, which is used as a performance bound. Additional results consider five types of 7-user scenarios, in which every BS observes a different SIR. Here, the structure (M_{T},N)×M_{R} means that the system selects N transmit antennas out of M_{T} and receives the transmitted signal with M_{R} antennas.

In more detail for an example two-user scenario, there are two adjacent cells and, consequently, two neighboring links. The UEs are positioned such that each BS observes the same SIR. One may define SIR at each BS as being

$$S I {R}_{q} = {( {\sum }_{r = 1 , r \neq q}^{Q} {g}_{rq} )}^{- 1} , ∀ q ∈ Γ . \qquad ( Eq . 14 )$$

Because the UEs are symmetrically positioned, they have the same performance in terms of BER and SIR₁=SIR₂=SIR. Thus, it is enough to illustrate only the average BER curves.

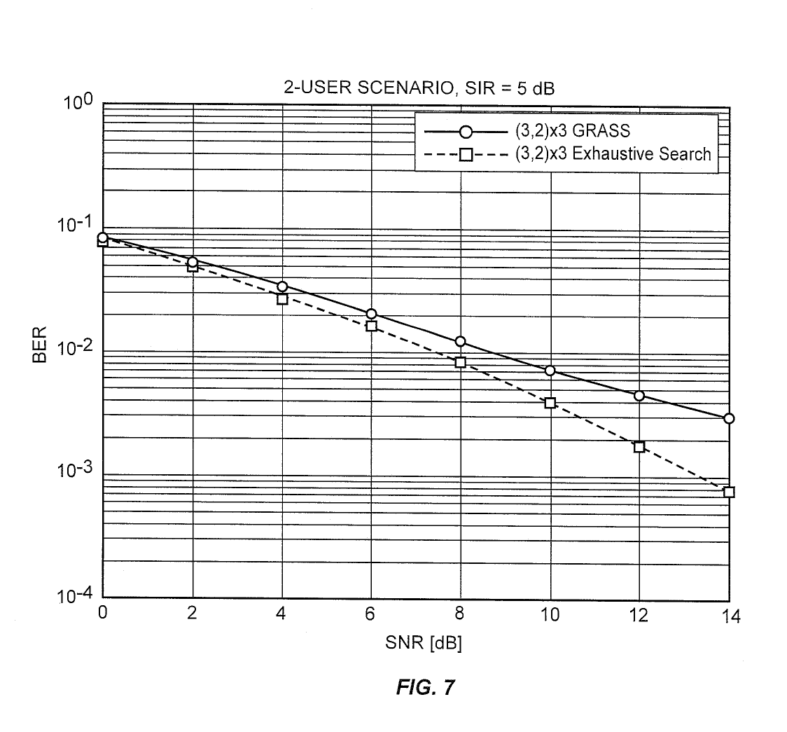

In FIG. 7, the GRASS algorithm has a performance loss compared to the lower bound represented by the (computationally expensive) exhaustive search. It is worth noting that the lower bound curve is drawn from a centralized algorithm that yields an optimal performance, whereas the GRASS algorithm may be considered suboptimal. However, the GRASS algorithm provides for a non-centralized (distributed) approach, which offers significant advantages when used in a wireless communication network. Besides that significant advantage, the performance of the GRASS algorithm is significantly close to the optimal. For BER equal to 10⁻², the penalty is approximately 1.3 dB.

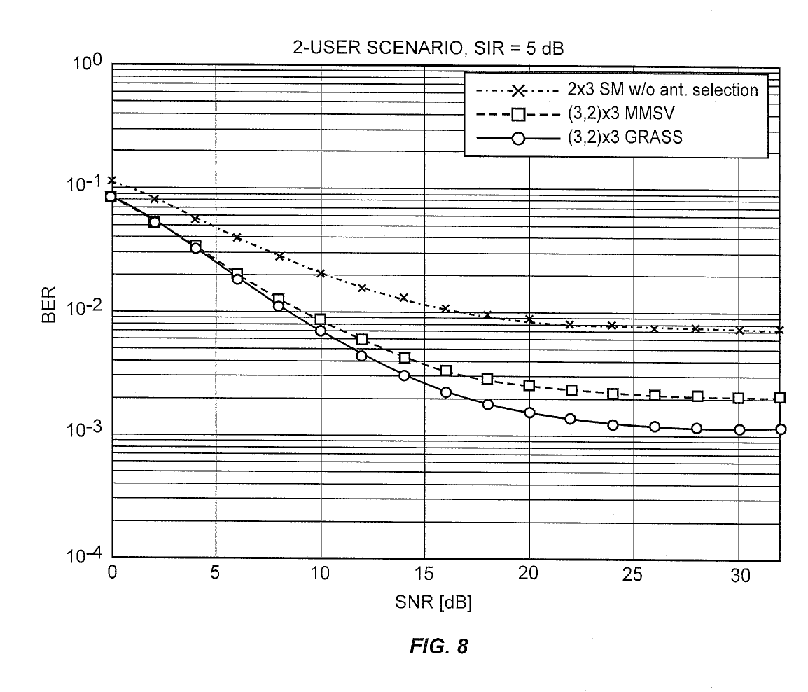

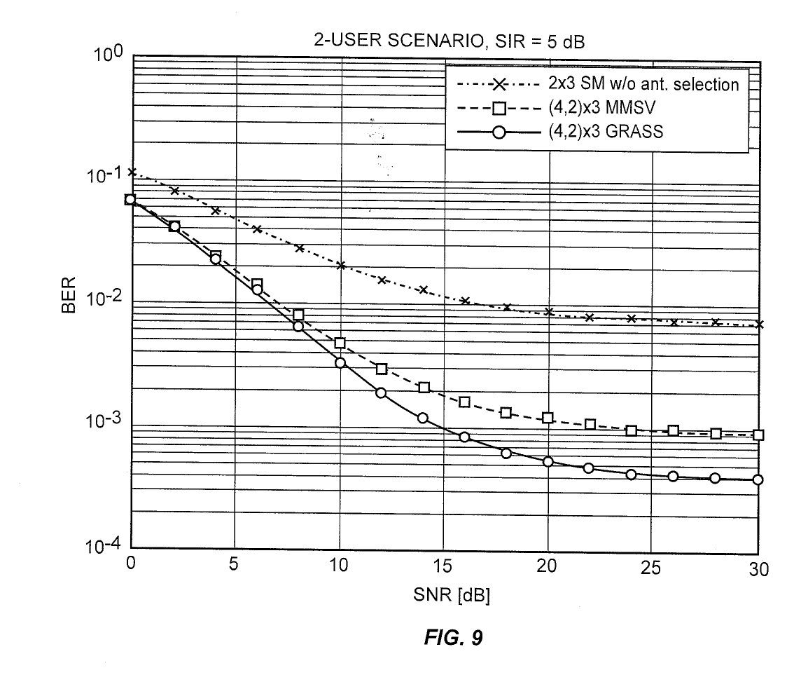

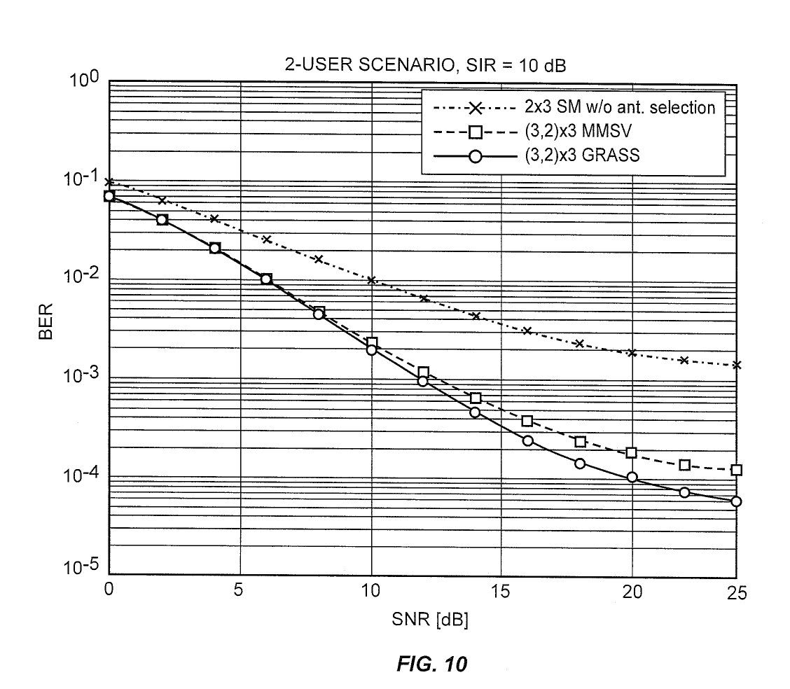

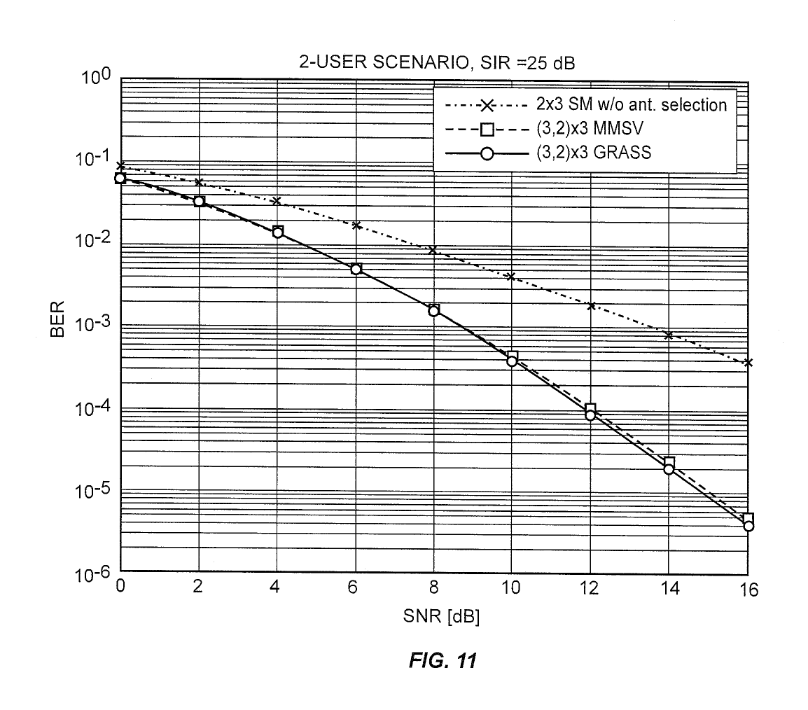

In FIGS. 8 and 9, one sees that the proposed game approach—the use of GRASS—achieves a lower BER floor as compared to MMSV. This performance advantage arises because the GRASS algorithm inherently mitigates MUI. On that point, as MUI decreases, the conflict aspect of the game is diminished. That is, there is no significant mutual interference between the links in high SIR regimes. Therefore, the game solution approaches the reference single user case in [4]. This behavior can be seen in FIGS. 10 and 11. In the former, the obtained performance gain is lower compared to FIG. 8, while in the latter the GRASS curve has almost no gain compared to the MMSV curve.

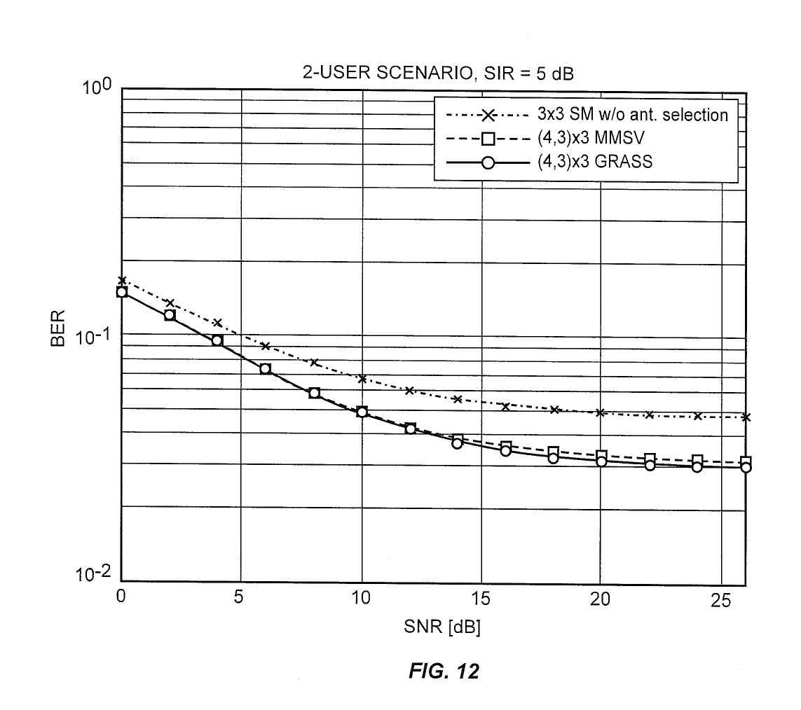

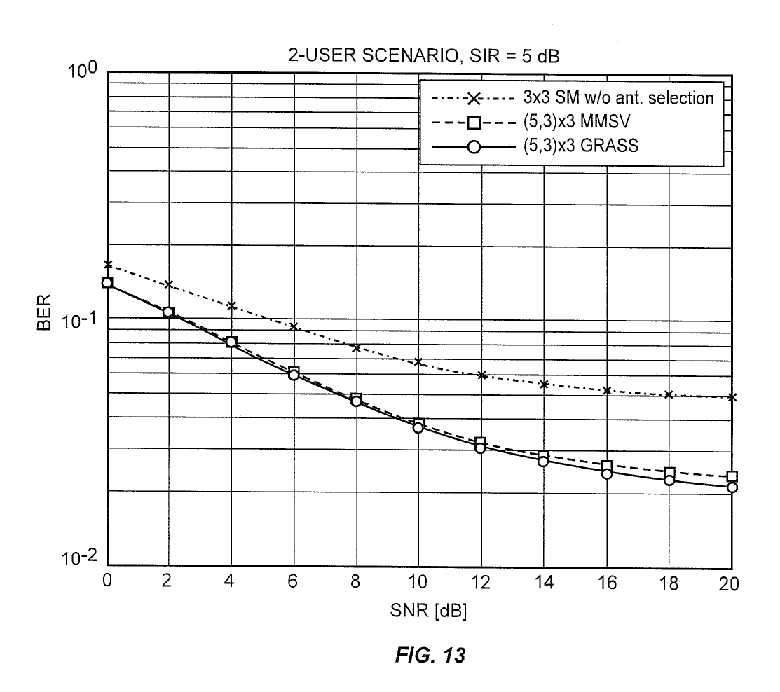

In FIGS. 12 and 13, the GRASS curve does not outperform significantly the MMSV curve, because the number of receive antennas is not larger than the amount of RF chains. In other words, there is not enough diversity to cancel the MUI and both algorithms perform relatively poorly with a BER floor of approximately 3·10⁻², approximately.

In a seven-user scenario, there are seven cells (1 central cell and 6 surrounding ones) and 7 neighboring users. That is, for this basic scenario, a first base station in a central cell supports a corresponding UE, where that UE is an interferer with respect to the radio links between six other neighboring UEs, each in one of the surrounding six cells and supported by the base station in that cell. As such, there are seven mutually interfering links, each link comprising a receiver/transmitter (BS/UE) pair.

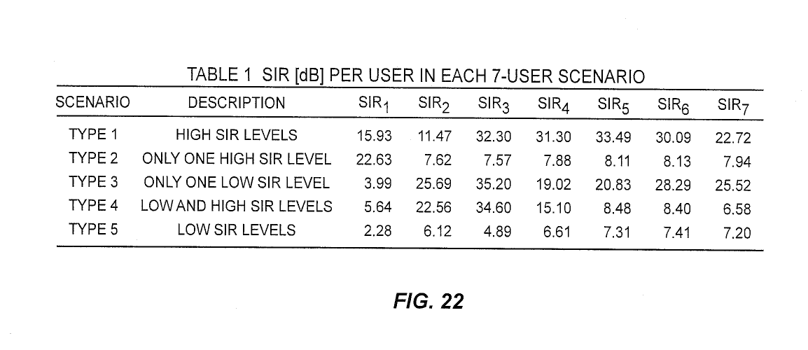

With Q=7, it is difficult to find symmetric user positions in the cells such that every BS observes the same SIR. Therefore, one may define five types of scenarios in which each user has different SIR levels. Each scenario is described in Table 1, which appears as the last figure, FIG. 22. Moreover, one may evaluate the system performance in terms of average BER, best-user BER (user with the higher SIR level) and worst-user BER (user with the lower SIR level).

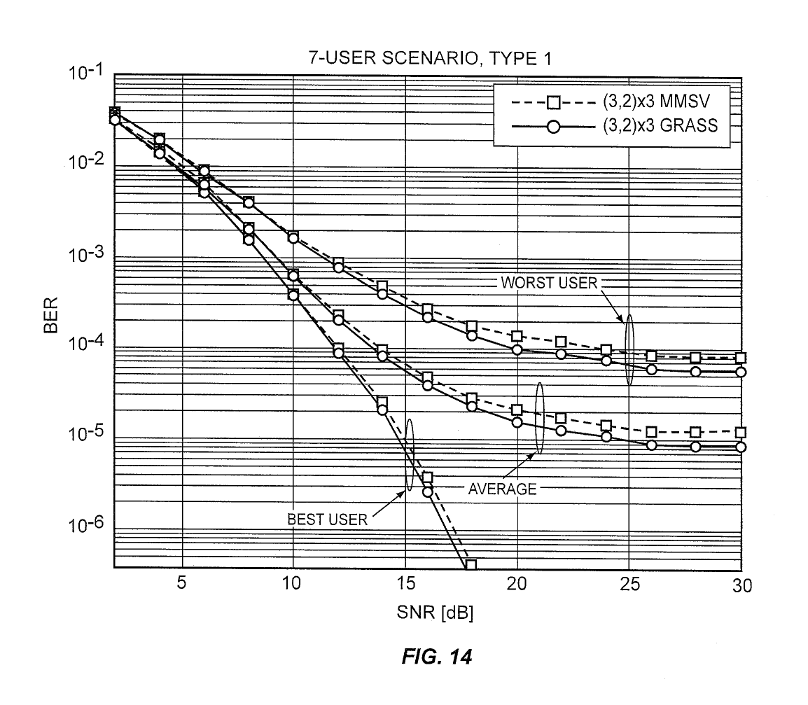

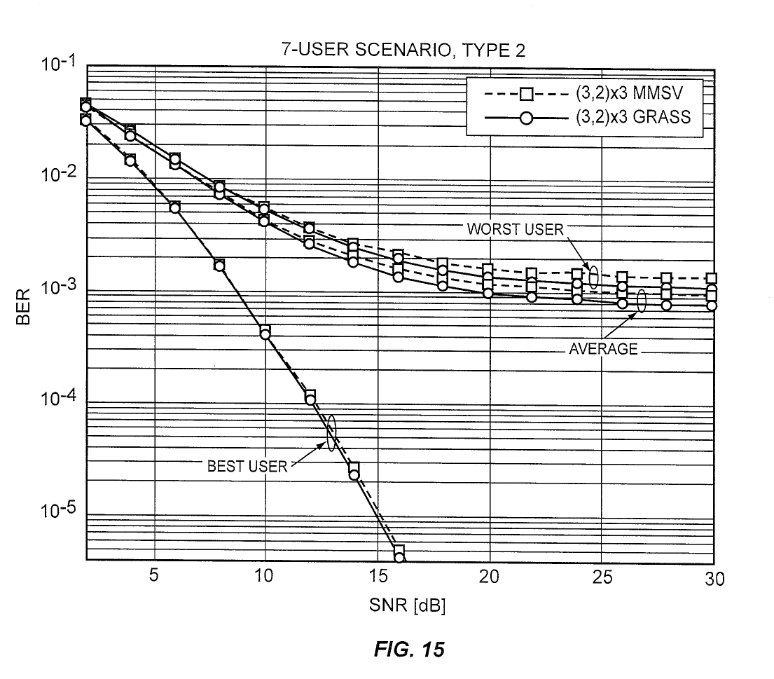

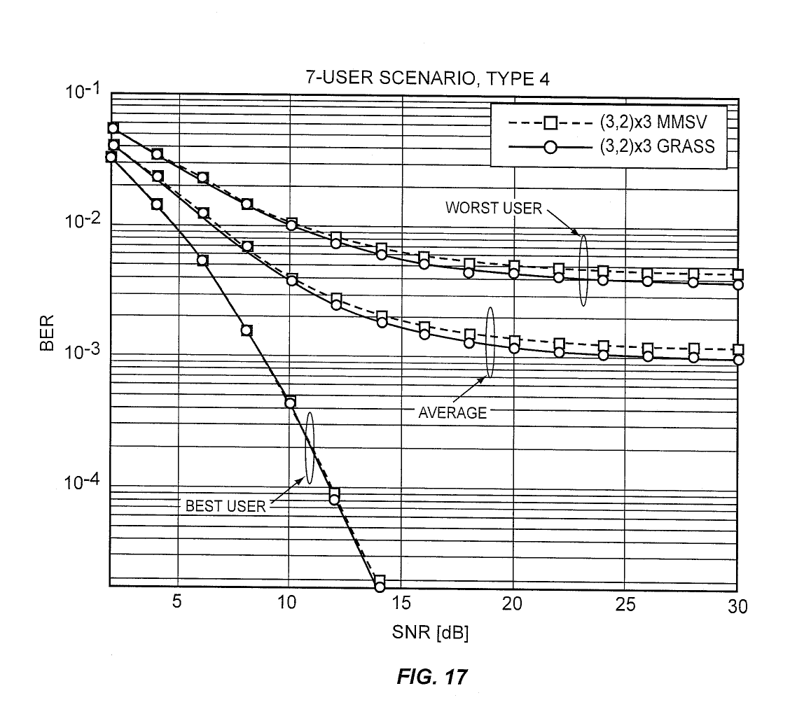

It is evident that the GRASS approach always outperforms the MMSV algorithm independently of the scenario type, which can be seen in FIGS. 14 through 18. However, the magnitude of this performance gain depends on the SIR level of each user.

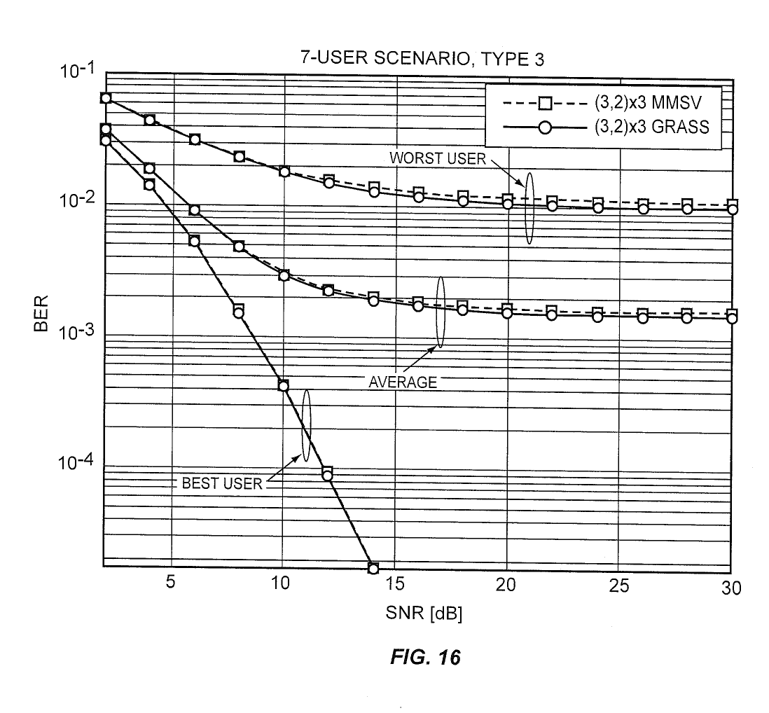

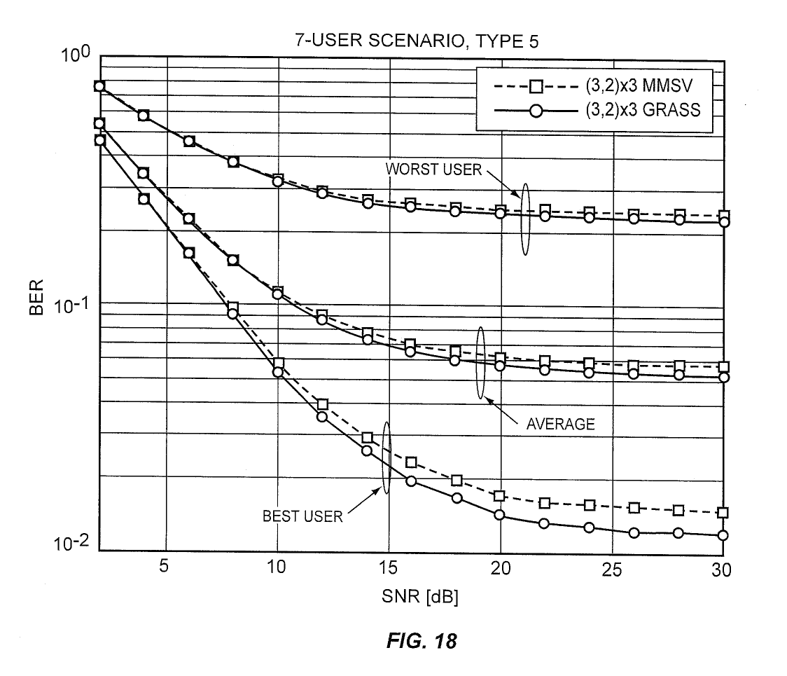

For example, from the curves, one may notice that if the SIR level is lower than 5 dB, the gain is significant small because the MUI is very strong and the algorithm does not manage to mitigate the interference satisfactorily. This behavior can be seen in FIGS. 16 and 18 for the worst-user case. One might also notice that the gain is quite small for high SIR levels (higher than 20 dB). This small gain may result because the MUI is very small for such cases, which means that the conflict of interest between the users becomes small, and, consequently, the game is not well driven. This behavior can be seen in FIGS. 14 through 17 for the best-user case.

On the other hand, the gain advantages become significant as the SIR levels range from 5 dB to 20 dB. For this SIR range, the conflict aspect of the proposed game-based approach is significant, and carrying out the game thus provides significant gains in MUI reduction. See, for example, FIGS. 14, 15 and 17 for the worst-user case as well as FIG. 18 for the best-user case.

Another aspect is the average behavior of the system in terms of BER, in which the gain is averaged over the individual gains obtained by each user. Thus, the SIR levels of the users reflect on this behavior directly. We see that the average gain does not appear significantly in FIG. 16 since the SIR₁ is very small and the remaining SIR levels are very high in scenario type 3. Throughout the other scenario types, there are a mixture of intermediate SIR levels with both high and low levels, which provides an considerable average gain.

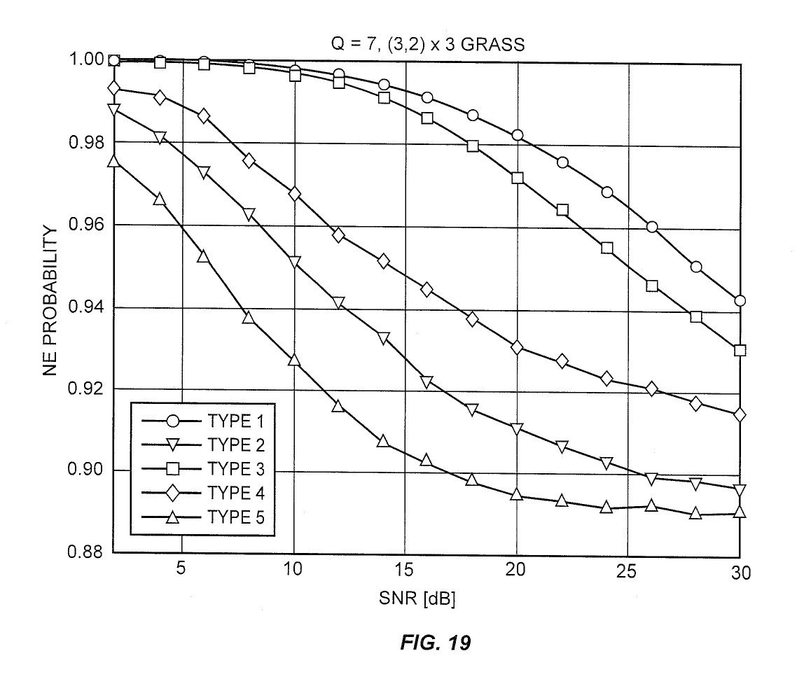

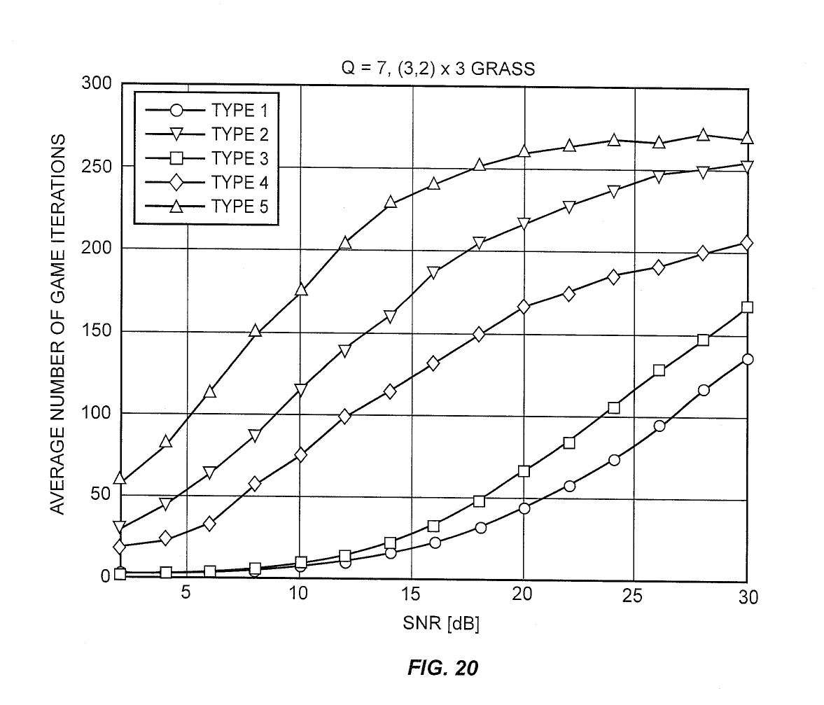

Finally, FIGS. 19 and 20 show the NE probability and the average number of game iterations, respectively. The NE probability decreases as the mutual MUI increases and becomes dominant compared to the noise factor in the denominator of (Eq. 9). Consequently, the number of game iterations increases because the lack of NE implies the use of the alternative algorithm MMSV triggered after 2 iterations.

Regardless, the present invention provides a number of significant performance and implementation advantages, for many real-world operating scenarios. A few non-limiting examples include these advantages: (1) the amount of information exchanged among BSs is decreased due to the non-centralized approach; (2) the MUI is mitigated since the payoff function of the game takes into account the SINR; and (3) the upper-bound λ is smaller than the number of interactions required by the exhaustive search algorithm.

Of course, the present invention is not limited by foregoing discussion or by the figures and tables that follow the abbreviations and references. For example, it will be understood that the base stations, base station controllers, and UEs (terminals) discussed herein may be implemented in hardware, software, or some combination of both.

In one example, a given base station is configured for use in a wireless communication network. In particular, the base station is configured to reduce MUI in MIMO uplink signals received from a first terminal. In this example, the base station comprises one or more processing circuits.

In one or more particular embodiments, the one or more base station processing circuits are configured to: determine a covariance estimate for co-channel interference caused by one or more additional terminals associated with additional, neighboring base stations. Here, the co-channel interference is dependent on which precoding matrixes from a defined set of precoding matrixes are in use for MIMO uplink transmission precoding by the one or more additional terminals. Also note that the additional, neighboring base stations are carrying out the same method.

Continuing, the one or more base station processing circuits are configured to evaluate a utility function over the defined set of precoding matrixes, to select the precoding matrix that maximizes a received signal quality of the MIMO uplink signals. Here, the utility function depends on the covariance estimate.

The processing circuits are further configured to send the selected precoding matrix to the first terminal, for subsequent use by the first terminal in MIMO uplink transmission precoding by the first terminal. Still further, the one or more processing circuits are configured to repeat the steps of determining, evaluating, and sending subject to determining that an equilibrium point has been reached as regards precoding matrix selection by the first base station and the one or more additional, neighboring base stations, or determining that an allowed limit on iterations has been reached.

Note that in one or more BSC-based embodiments, each BS estimates all the channels from the other UEs to that BS. With this information and the precoder indexes from the other UEs (provided by the BSC), the BS chooses the precoder of its associated UE. However, in one or more embodiments where the BSC is not used, every BS estimates the corresponding covariance matrix R_{-q} and uses only this information to choose the precoder of its associated UE. In embodiments that use the BSC, every BS calculates the matrix R_{-q} (which is the noise-plus-interference covariance matrix). The interference covariance is calculated based on the messages received via the BSC and the channel matrixes which have already been estimated in a previous step.

On the other hand, when the BSC or other centralized entity for exchanging game information between participating BSs is not used, the covariance matrix itself has to be estimated at each participating BS. This approach can be less accurate, depending on estimation errors, but still yields significant interference reduction.

Also, note that, in one or more BSC-based embodiments, an equilibrium point is reached when each BS detects repeated selections of the same precoding matrix for the other UEs. Thus, a strict synchronization is not necessary in this approach. In one or more non-BSC embodiments, an equilibrium point is reached when each BS detects repeated covariance estimates. That is, because BSC-based exchanges of precoding matrix selections are not used, the BS does not know the precoding matrixes selected by the other UEs. Therefore, each participating BS looks at the behavior of its covariance estimate to detect equilibrium. In at least one such embodiment, the interference estimation at each BS is based on all pilots (from its own UE and from the interfering UEs), so game play may use a common period of time for such pilot transmission—e.g., a synchronized time for pilot transmission, so that all game-playing BSs can make the interference estimates needed to advance game play.

It will be understood then, that a base station as taught herein is configured to implement a method of reducing multi-user interference (MUI) in multiple-input-multiple-output (MIMO) uplink signals received from a first terminal. In at least one embodiment, the method includes determining a covariance estimate for co-channel interference caused by one or more additional terminals associated with additional, neighboring base stations. Here, the co-channel interference is dependent on which precoding matrixes from a defined set of precoding matrixes are in use for MIMO uplink transmission precoding by the one or more additional terminals, and said additional, neighboring base stations are carrying out the same method. The method further includes evaluating a utility function over the defined set of precoding matrixes, to select the precoding matrix that maximizes a received signal quality of the MIMO uplink signals, said utility function depending on the covariance estimate. Still further, the method includes sending information identifying the selected precoding matrix to at least one of a base station controller acting as a central distribution node for exchanging precoding matrix selection information among the first and neighboring base stations, for carrying out the method, or to the first terminal, for subsequent use by the first terminal in MIMO uplink transmission precoding by the first terminal.

Further, the method includes repeating the steps of determining, evaluating, and sending subject to determining that an equilibrium point has been reached as regards precoding matrix selection by the first base station and the one or more additional, neighboring base stations, or determining that an allowed limit on iterations has been reached. If either one has been reached (i.e., either equilibrium or the allowed limit), the first base station sends information identifying the final precoding matrix for its associated first terminal. (Likewise, each of the neighboring base stations also sends information identifying their final precoding matrix selections, for their respectively associated terminals.) The finally-selected precoding matrixes are used by the respectively associated terminals for MIMO uplink precoding.

In the above embodiments, and in other contemplated embodiments, the base station's one or more processing circuits are implemented via hardware, software, or some combination of both. For example, the base station includes radio transceivers for transmitting signals on the downlink and receiving signals on the uplink—e.g., MIMO transceiver circuits. The base station further includes the aforementioned one or more processing circuits, which for example comprise one or more microprocessor-based circuits, or other digital processor-based circuitry. In at least one such embodiment, the base station includes memory or another computer-readable medium, storing a computer program that comprises program instructions for implementing gaming-based precoding matrix selection as taught herein—e.g., for implementing the GRASS algorithm as presented herein.

In a particular example, the base station's one or more processing circuits include one or more channel estimators, for estimating propagation channel characteristics between the base station and its associated terminal (and with respect to the interfering terminals). The processing circuit(s) also include a covariance estimator, for estimating covariance as described herein; a utility function evaluator that is configured to evaluate the utility function, to identify the signal-quality maximizing precoding matrix, and select it for use by the associated UE. Still further, the base station will be understood to include MIMO radio transceivers, operatively associated with the one or more processing circuits, for receiving uplink signals and transmitting downlink signals.

Similarly, the BSC may include one or more computer-based processing circuits, along with appropriate communication interfaces, for implementing the message processing described herein. Still further, it will be understood that the UEs as contemplated herein may be implemented at least in part via software configuration, and that a given UE (cellular phone, computer modem, PDA, pager, or some other such terminal or other wireless communication device) includes a (MIMO) radio transceiver having a plurality of antennas for MIMO transmission and reception.

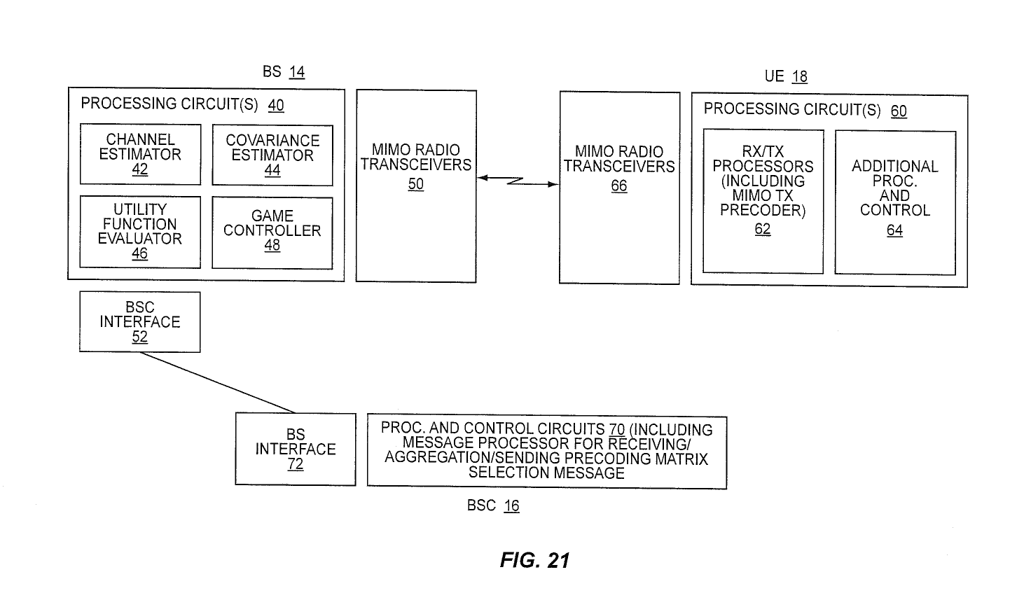

Examples of the above configurations for the BS, BSC, and UE are shown in FIG. 21, by way of example rather than limitation. The BS 14 includes one or more processing circuits 40, including a channel estimator 42, a covariance estimator 44, a utility function evaluator 46, and a game controller 48, along with MIMO radio transceivers 50, and a BSC interface 52. The UE 18 includes one or more processing circuits 60, including receive/transmit (RX/TX) processors 62, and additional processing and control circuits 64. The UE 18 further includes MIMO radio transceiver(s) 66. Finally, the BSC 16 includes processing and control circuits 70, as illustrated, along with a BS interface 72. These illustrated elements are configured according to one or more embodiments of the interference-reducing game play described herein.

With these and other aspects of implementation flexibility in mind, those skilled in the art will appreciate that the present invention should be broadly understood as providing a distributed, game-theory based approach to reducing MUI.

More particularly, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### REFERENCES

[1] Paulraj, A., Nabar, R., and Gore, D., Introduction to Space-Time Wireless Communications. Cambridge, UK: Cambridge University Press, 2003.
[2] Telatar, Emre, “Capacity of Multi-antenna Gaussian Channels,” European Transactions on Telecommunications, vol. 10, pp. 585-595, 1999. [Online]. Available: http://citeseer.ist.psu.edu/346880.html.
[3] Nabar, R. U., Gore, D. A., and Paulraj, A., “Optimal selection and use of transmit antennas in wireless systems,” in International Conference on Telecommunications (ICT), Acapulco, Mexico, 2000.
[4] Heath, Jr., R. W., Sandhu, S., and Paulraj, A., “Antenna selection for spatial multiplexing systems with linear receivers,” IEEE Communications Letters, vol. 5, no. 4, pp. 142-144, April 2001.
[5] MacKenzie, A. B. and DaSilva, L. A., Game Theory for Wireless Engineers. USA: Morgan & Claypool, 2006.
[6] Scutari, G., Palomar, D. P., and Barbarossa, S., “Competitive design of multi-user mimo systems based on game theory: A unified view,” IEEE Journal on Selected Areas in Communications, vol. 26, no. 7, pp. 1089-1103, September 2008.
[7] Menon, R., Mackenzie, A., Hicks, J., Buehrer, R., and Reed, J., “A game-theoretic framework for interference avoidance,” IEEE Transactions on Communications, vol. 57, no. 4, pp. 1087-1098, April 2009.
[8] Scutari, G., Palomar, D. P., and Barbarossa, S., “Optimal Linear Precoding Strategies for Wideband Noncooperative Systems Based on Game Theory—Part I: Nash Equilibria,” IEEE Transactions on Signal Processing, vol. 56, no. 3, pp. 1230-1249, March 2008.
[9]H. G. Myung, J. Lim, and D. J. Goodman, “Single carrier FDMA for uplink wireless transmission,” IEEE Vehicular Technology Magazine, vol. 1, no. 3, pp. 30-38, September 2006.
[10] Andrews, J. G., Choi, Wan, and Heath, Jr., R. W., “Overcoming interference in spatial multiplexing MIMO cellular networks,” IEEE Wireless Communications, vol. 14, no. 6, pp. 95-104, December 2007.
[11] Palomar, D. P. and Barbarossa, S., “Designing MIMO communication systems: constellation choice and linear transceiver design,” IEEE Transactions on Signal Processing, vol. 53, no. 10, pp. 3804-3818, October 2005.
[12] Basar, T. and Olsder, G. J., Dynamic Noncooperative Game Theory. Great Britain Harcourt Brace & Company, 1995.

What is claimed is:

1. In a first base station for use in a wireless communication network, a method of reducing multi-user interference (MUI) in multiple-input-multiple-output (MIMO) uplink signals received from a first terminal, the method comprising:
determining a covariance estimate for co-channel interference caused by one or more additional terminals associated with additional, neighboring base stations, wherein said co-channel interference is dependent on which precoding matrixes from a defined set of precoding matrixes are in use for MIMO uplink transmission precoding by the one or more additional terminals, and said additional, neighboring base stations are carrying out the same method;
evaluating a utility function over the defined set of precoding matrixes, to select the precoding matrix that maximizes a received signal quality of the MIMO uplink signals, said utility function depending on the covariance estimate;
sending information identifying the selected precoding matrix to at least one of a base station controller acting as a central distribution node for exchanging precoding matrix selection information among the first and neighboring base stations, for carrying out the method, or to the first terminal, for subsequent use by the first terminal in MIMO uplink transmission precoding by the first terminal; and
repeating said steps of determining, evaluating, and sending subject to determining that an equilibrium point has been reached as regards precoding matrix selection by the first base station and the one or more additional, neighboring base stations, or determining that an allowed limit on iterations has been reached.

2. The method of claim 1, further comprising, in response to determining that the equilibrium point has been reached or that the allowed limit on iterations has been reached, sending information identifying the final precoding matrix to the first terminal, for use by the first terminal in MIMO uplink precoding.

3. The method of claim 1, wherein said step of determining comprises receiving messages from a base station controller that indicate the selected precoding matrixes in use at the one or more additional terminals, and computing the covariance estimate as an estimate of the noise and interference covariance, based on knowledge of the selected precoding matrixes in use at the one or more additional terminals.

4. The method of claim 1, wherein said step of determining comprises receiving pilot signals from the first terminal and the one or more additional terminals, wherein those pilot signals are transmitted from each terminal using a selected precoding matrix, generating channel estimates relating the first base station to the first terminal, and relating the first base station to the one or more additional terminals, and computing the covariance estimate based on the channel estimates and the received pilot signals.

5. The method of claim 1, further comprising, upon said determining that the allowed limit on iterations has been reached, using a non-iterative algorithm to select the precoding matrix to be used by the first terminal.

6. The method of claim 1, further comprising, upon said determining that the allowed limit on iterations has been reached, using a MMSV algorithm to select the precoding matrix to be used by the first terminal.

7. A base station for use in a wireless communication network, said base station configured to reduce multi-user interference (MUI) in multiple-input-multiple-output (MIMO) uplink signals received from a first terminal, and said base station comprising one or more processing circuits configured to:
determine a covariance estimate for co-channel interference caused by one or more additional terminals associated with additional, neighboring base stations, wherein said co-channel interference is dependent on which precoding matrixes from a defined set of precoding matrixes are in use for MIMO uplink transmission precoding by the one or more additional terminals, and said additional, neighboring base stations are carrying out the same method;
evaluate a utility function over the defined set of precoding matrixes, to select the precoding matrix that maximizes a received signal quality of the MIMO uplink signals, said utility function depending on the covariance estimate;
send information identifying the selected precoding matrix to a base station controller acting as a central distribution node for exchanging precoding matrix selection information among the first and neighboring base stations, for carrying out the method, or to the first terminal, for subsequent use by the first terminal in MIMO uplink transmission precoding by the first terminal; and
repeat said steps of determining, evaluating, and sending subject to determining that an equilibrium point has been reached as regards precoding matrix selection by the first base station and the one or more additional, neighboring base stations, or determining that an allowed limit on iterations has been reached.

8. The base station of claim 7, wherein, in response to determining that the equilibrium point has been reached or that the allowed limit on iterations has been reached, the base station is configured to send information identifying the final precoding matrix to the first terminal, for use by the first terminal in MIMO uplink precoding.

9. The base station of claim 7, wherein the base station is configured to determine the covariance estimate based on receiving messages from a base station controller that indicate the selected precoding matrixes in use at the one or more additional terminals, and computing the covariance estimate as an estimate of the noise and interference covariance, based on knowledge of the selected precoding matrixes in use at the one or more additional terminals.

10. The base station of claim 7, wherein the base station is configured to determine the covariance estimate based on receiving pilot signals from the first terminal and the one or more additional terminals, wherein those pilot signals are transmitted from each terminal using a selected precoding matrix, generating channel estimates relating the first base station to the first terminal, and relating the first base station to the one or more additional terminals, and computing the covariance estimate based on the channel estimates and the received pilot signals.

11. The base station of claim 7, wherein the base station is configured to use a non-iterative algorithm to select the precoding matrix to be used by the first terminal, in response to said determining that the allowed limit on iterations has been reached.

12. The base station of claim 7, wherein the base station is configured to use a MMSV algorithm to select the precoding matrix to be used by the first terminal, in response to said determining that the allowed limit on iterations has been reached.

13. A base station controller (BSC) configured for use in a wireless communication network, said BSC comprising one or more processing circuits configured to:
receive a message from each in a plurality of base stations, said message identifying a precoding matrix in use for multiple-input-multiple-output (MIMO) uplink precoding by a terminal supported by the base station;
aggregate the messages together, to form one or more combined messages; and
send one or more of the one or more combined messages to each base station in the plurality of base stations, to thereby share among the plurality of base stations all of the precoding matrix selections that are in use.

14. The BSC of claim 13, wherein the BSC is configured to form a combined message for each given base station in the plurality of base stations, wherein the combine message includes precoding matrix selections in use at the other base stations, but omits the precoding matrix selection in use at the given base station, as such selection is already known to the given base station.

15. A method of reducing multi-user interference (MUI) for a set of base stations and a corresponding set of terminals, wherein each base station is associated with a respective one of the terminals and wherein the terminals represent inter-cell interferers with respect to one another, said method comprising, at each base station:
in a first iteration:
determining a covariance estimate for multi-user interference at the base station, as caused by the other terminals, wherein the covariance estimate depends on which particular precoding matrixes, from among a defined set of precoding matrixes, are in use at respective ones of the other terminals for multiple-input-multiple-output (MIMO) uplink transmissions;
evaluating a utility function that depends on the precoding matrix selected from the defined set of precoding matrixes, and the covariance estimate, to find and select the precoding matrix that maximizes a received signal quality of MIMO uplink signals from the associated terminal; and
in one or more next iterations:
revising the covariance estimate to account for new precoding matrix selections by the other base stations, and re-evaluating the utility function to again find and select the precoding matrix that maximizes the received signal quality of MIMO uplink signals from the associated terminal;
compare the revised covariance estimate with the previous one in order to determine if either an equilibrium point has been reached or an allowed number of iterations has been reached

16. The method of claim 15, further comprising, in response to determining that the equilibrium point has been reached or that the allowed number of iterations has been reached, considering a current iteration as the last iteration.

17. The method of claim 15, further comprising, in each iteration except a last iteration, performing one of:
sending information identifying the selected precoding matrix to the associated terminal, for use by the associated terminal in MIMO uplink precoding, wherein each terminal sends a pilot signal based on said information, so that each base station estimates the interference caused by the other terminals; or
sending information identifying the selected precoding matrix to a base station controller that is communicatively coupled to the set of base stations, wherein the base station controller distributes said information among the set of base stations, so that each base station knows the precoding matrixes selected by the other base stations.

18. The method of claim 15, further comprising, in a last iteration, at each base station, sending information identifying the final selected precoding matrix to the associated terminal, for use by the associated terminal in MIMO uplink precoding.

19. A method of reducing multi-user interference (MUI) in multiple-input-multiple-output (MIMO) uplink signals received from a first terminal at a first base station that is configured for use in a wireless communication network, the method comprising:
determining which precoding matrixes from a defined set of precoding matrixes are in use for MIMO uplink transmission precoding by one or more additional, interfering terminals, wherein additional, neighboring base stations are carrying out the same method;
selecting the precoding matrix from the defined set of precoding matrixes that maximizes a received signal quality of the MIMO uplink signals from the first terminal at the first base station, said selection based at least in part on said determining which precoding matrixes are in use by the one or more other terminals;
sending information identifying the selected precoding matrix to a base station controller acting as a central distribution node for exchanging precoding matrix selection information among the first and neighboring base stations, for carrying out the method, or to the first terminal, for subsequent use by the first terminal in MIMO uplink transmission precoding by the first terminal; and
repeating said steps of determining, selecting, and sending in one or more iterations, subject to determining that an equilibrium point has been reached as regards precoding matrix selection by the first base station and the neighboring base stations, or determining that an allowed limit on iterations has been reached.

20. The method of claim 19, further comprising, in response to determining that the equilibrium point has been reached or that the allowed limit on iterations has been reached, sending information identifying the final precoding matrix, as selected by the first base station, to the first terminal, for use by the first terminal in MIMO uplink precoding.
